(19) United States
(12) Patent Application Publication
(10) Pub. No.: US 2011/0253307 A1
(43) Pub. Date: Oct. 20, 2011

(54) Method of Manufacturing A Touch Screen Device

(75) Inventor: Jong Young LEE, Gyunggi-do (KR)

(73) Assignee: SAMSUNG ELECTRO-MECHANICS CO., LTD., Gyunggi-do (KR)

(21) Appl. No.: 12/838,406

(22) Filed: Jul. 16, 2010

(30) Foreign Application Priority Data
Apr. 19, 2010 (KR) 10-2010-0035822

(51) Int. Cl. B32B 37/12

(52) U.S. Cl. 156/285

(57) ABSTRACT

Disclosed herein is a method of manufacturing a touch screen device. The method of manufacturing a touch screen device includes: (A) disposing an adhesive layer for a transparent substrate of a touch screen and a stacked member; (B) disposing the transparent substrate of the touch screen, the stacked member, and the adhesive layer into a vacuum bag, disposing the vacuum bag into a chamber, and then removing voids formed between the transparent substrate and the adhesive layer, between the stacked member and the adhesive layer, or both of them by pressurizing, or pressurizing and heating the inside of the chamber; and(C) extracting the transparent substrate of the touch screen, the stacked member, and the adhesive layer from the chamber and the vacuum bag, in which visibility is improved by removing voids generated in the adhesive layer when the touch screen and the stacked member are bonded over the entire surface.

### CROSS REFERENCE TO RELATED APPLICATION

This application claims the benefit of Korean Patent Application No. 10-2010-0035822, filed on Apr. 19, 2010, entitled “Method Of Manufacturing A Touch Screen Device”, which is hereby incorporated by reference in its entirety into this application.

### BACKGROUND OF THE INVENTION

1. Technical Field

The present invention relates to a method of manufacturing a touch screen device.

2. Description of the Related Art

With continuous development of the electronic engineering technology and the information technology, the relative importance of electronic devices is constantly increasing in everyday life, including works. In particular, as the electronic technology develops, personal computers and portable transmitters etc. process texts and graphics, using a variety of input devices, such as a keyboard, a mouse, and a digitizer. These input devices, however, have been designed in consideration for the use of personal computers, such that they are difficult to be applied to portable devices that are reduced in size and thickness. Therefore, touch screens as an input unit for portable devices have considerably increased.

Touch screens, devices usually installed in display devices to detect positions on the picture, which a user touches, and controlling electronic elements, using input information based on the detected contact position, in addition to controlling the picture of the display, have various advantages of being simply operated with little malfunction in a small space and very compatible with IT devices.

On the other hand, with the development of mobile communication technology, it is required to implement larger-sized display picture in a limited-sized portable devices, and accordingly, the type of display using the touch screens has become the main focus. Further, touch screens have the advantage of saving a space, as compared with the key input type of the prior art, by integrating the screen with the coordinate input unit. Therefore, display devices that have been developed in recent years have been equipped with displays using the touch screens in order to more increase the screen size and improve convenience for users.

FIG. 1 is a cross-sectional view of a touch screen device 10 according to an example of the prior art. The touch screen device 10 according to an example of the prior art is described with reference to the figure as follows.

As shown in FIG. 1, in the touch screen device 10 of the prior art, a touch screen 11 and a display 12 are bonded by a double-sided adhesive tape (DAT) 13. In this configuration, the double-sided adhesive tape 13 bonds the touch screen 11 with the display 12 at the edges between the touch screen 11 and the display 12.

In the touch screen device 10 according to an example of the prior art, however, since the double-sided adhesive tape 13 is disposed at the edges between the touch screen 11 and the display 12, an air layer 14 is formed at the inside between the touch screen 11 and the display 12, such that there was a problem that transmittance of an image displayed on the display 12 is deteriorated.

In order to remove the problem, researches for replacing the double-sided adhesive tape 13 with an optical clear adhesive (OCA) have been conducted to remove the air layer 14 between the touch screen 11 and the display 12.

FIG. 2 is a cross-sectional view of a touch screen device 20 according to another example of the prior art. The touch screen device 20 according to another example of the prior art is described with reference to the figure as follows.

As shown in FIG. 2, in the touch screen device 20 of the prior art, a touch screen 21 and a display 22 are bonded by an optical clear adhesive 23. In this configuration, the optical clear adhesive 23 is made of a transparent material and disposed over the entire surface between the touch screen 21 and the display 22. Therefore, an air layer was not formed between the touch screen 21 and the display 22, which improved transmittance.

The touch screen 20 according to another embodiment of the prior art, however, has a problem that even if the touch screen 21 and the display 22 are well polished and then bonded, voids 24 are formed due to the air layer remaining therebetween. The voids 24 are formed between the touch screen 21 and the optical clear adhesive 23 and between the display 22 and the optical clear adhesive 23 and create spots on the picture, such that there was a problem in that an image on the display 22 is refracted and distorted.

### SUMMARY OF THE INVENTION

The present invention has been made in effort to provide a method of manufacturing a touch screen that improves visibility by removing voids generated in an adhesive layer when a transparent substrate of a touch screen and a stacked member are bonded over the entire surface.

A method of manufacturing a touch screen device according to a preferred embodiment of the present invention includes: (A) disposing an adhesive layer for a transparent substrate of a touch screen and a stacked member; (B) disposing the transparent substrate of the touch screen, the stacked member, and the adhesive layer into a vacuum bag, disposing the vacuum bag into a chamber, and then removing voids formed between the transparent substrate and the adhesive layer, between the stacked member and the adhesive layer, or both of them by pressurizing, or pressurizing and heating the inside of the chamber; and (C) extracting the transparent substrate of the touch screen, the stacked member, and the adhesive layer from the chamber and the vacuum bag.

Step (B) includes: (B1) disposing the transparent substrate of the touch screen, the stacked member, and the adhesive layer into the vacuum bag and then disposing the vacuum bag into the chamber; and (B2) removing voids formed between the transparent substrate and the adhesive layer, between the stacked member and the adhesive layer, or both of them by pressurizing, or heating and pressurizing the inside of the chamber, with the inside of the vacuum bag kept vacuum.

Further, step (B) includes: (B1) disposing the transparent substrate of the touch screen, the stacked member, and the adhesive layer into the vacuum bag and keeping the inside of the vacuum bag vacuumed; and (B2) disposing the vacuum bag into the chamber and removing voids formed between the transparent substrate and the adhesive layer, between the stacked member and the adhesive layer, or both of them by pressurizing, or heating and pressurizing the inside of the chamber.

Further, the stacked member is a display.

Further, the stacked member is a window plate protecting the touch screen.

Further, the stacked member is another transparent substrate opposite to the transparent substrate of the touch screen.

Further, step (A) includes: (A1) disposing an adhesive layer between the transparent substrate of the touch screen and the stacked member; and (A2) temporarily bonding the transparent substrate with the stacked member, using adhesion of the adhesive layer.

### BRIEF DESCRIPTION OF THE DRAWINGS

FIG. 1 is a cross-sectional view of a touch screen device according to an example of the prior art;

FIG. 2 is a cross-sectional view of a touch screen device according to another example of the prior art;

FIG. 3 is a cross-sectional view of a touch screen device according to a preferred embodiment of the present invention; and

FIGS. 4 to 8 are views illustrating a method of manufacturing a touch screen device according to a preferred embodiment of the present invention.

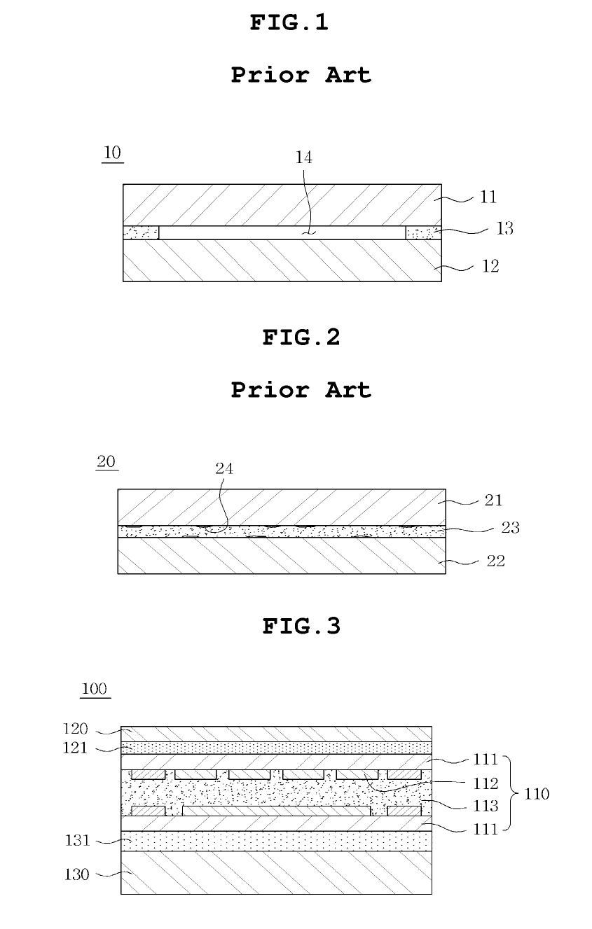

### DESCRIPTION OF THE PREFERRED EMBODIMENTS

Various objects, advantages and features of the invention will become apparent from the following description of embodiments with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. Further, in describing the present invention, a detailed description of related known functions or configurations will be omitted so as not to obscure the subject of the present invention.

Hereinafter, preferred embodiments of the present invention will be described in detail with reference to the accompanying drawings.

### Structure of Touch Screen Device

FIG. 3 is a cross-sectional view of a touch screen device 100 according to a preferred embodiment of the present invention. The touch screen device 100 according to this embodiment is described with reference the figure as follows.

As shown in FIG. 3, the touch screen device 100 according to this embodiment includes a touch screen 110, and may further include a window plate 120, a display 130, a first adhesive layer 121, and a second adhesive layer 131.

The touch screen 110 is a member that receives an input from a user and transmits feedback about the input to the display 130 or a controller (not shown), and for example, resistive and capacitive touch screens can be used. Although, as an example, a capacitive touch screen 110 having two opposite transparent substrates 111 is described in this embodiment, it should be understood that the present invention is not limited thereto and includes a configuration with one transparent substrate 111 or the resistive touch screen.

In this configuration, the touch screen 110 may include two transparent substrates 111, transparent electrodes 112, and a spacer 113.

The transparent substrates 111 are members providing a space where the transparent electrodes 112 are formed, while protecting the touch screen 110.

In this configuration, the transparent substrates 111 are made of a transparent material such that a user is able to see the display well, and for example, may be made of polyethylene terephthalate (PET) or glass. Further, it is preferable to apply high-frequency treatment or primer treatment to the transparent substrates 111 to improve the attachment with the transparent electrodes 112.

The transparent electrodes 112 are elements formed on one side of the transparent substrates 111 and senses signals from contact or access of specific objects.

In this configuration, the transparent electrodes 112 senses changes in capacitance due to contact or access of a specific object, such as the user's body or a stylus pen, and transmit the changes to the controller (not shown), and then the controller (not shown) converts the analog signals into digital signals and simultaneously recognizes the coordinates of the pushed position, thereby implementing desired operations. In detail, when high frequency is dispersed throughout the transparent electrodes 112 by an applied voltage and then there is contact or access of a human body etc., a predetermined change occurs in capacitance while the transparent electrodes 112 function as electrodes and the transparent substrates 111 function as dielectrics, and the controller (not shown) can recognize the contact position or whether there is access, by detecting the changed waveform.

Meanwhile, the transparent electrodes 112 are made of a transparent material for a user to be able to see the display 130 under them, and preferably have conductivity. For example, the transparent electrodes 112 may be made of conductive polymer, such as, poly-3,4-ethylenedioxythiophene/polystyrenesulfonate (PEDOT/PSS), polyaniline, or a mixture thereof, or metal oxides, such as indium tin oxide (ITO). Further, the transparent electrodes 112 may have various shapes, such as a rod shape, a diamond shape, a hexagonal shape, an octagonal shape, and a triangular shape.

The spacer 113 insulates transparent electrodes 112 on the transparent substrates 111, bonding the two transparent substrates 111. In this configuration, although the material of the spacer 113 is not specifically limited, it is preferable to use an optical clear adhesive (OCA) having both insulation and adhesiveness.

The window plate 120 is a member formed on one of the transparent substrates 111 to protect the touch screen 110.

In this configuration, the window plate 120 is a part receiving an input from a specific object, such as the user's body or the stylus pen and maintains the outer shape of the input part of the touch screen 110. Therefore, it is possible that the window plate 120 is made of a material having high durability to sufficiently protect the touch screen 110 from an external force. Further, the window plate 120 is made of a transparent material for a user to be able to see the display well, and for example, may be made of polyethylene terephthalate (PET) or glass.

Meanwhile, the window plate 120 is bonded to one of the transparent substrates 111 by the first adhesive layer 121. In this configuration, the first adhesive layer 121 bonds the window substrate 120 and the transparent substrate 111 over the entire surface. Further, because the first adhesive layer 121 is preferably formed over the entire surface and made of a transparent material, for example, it may be made of an optical clear adhesive (OCA).

The display 130 is a member formed under the other transparent substrate 111 to display images to the user.

In this configuration, the display 130 is a member for displaying images for information transmission to the user and showing reaction when the user touches the touch screen 110, to the user. The display 130 may be, for example, a liquid crystal display (LCD), a plasma display panel (PDP), an electroluminescence (EL), or a cathode ray tube (CRT).

Meanwhile, the display 130 is bonded to the other transparent substrate 111 through the second adhesive layer 131. In this configuration, since the second adhesive layer 131 is formed over the entire surface between the display 130 and the other transparent substrate 111, for example, it is preferable that it is made of a transparent material, such as an optical clear adhesive (OCA).

### Method of Manufacturing Touch Screen

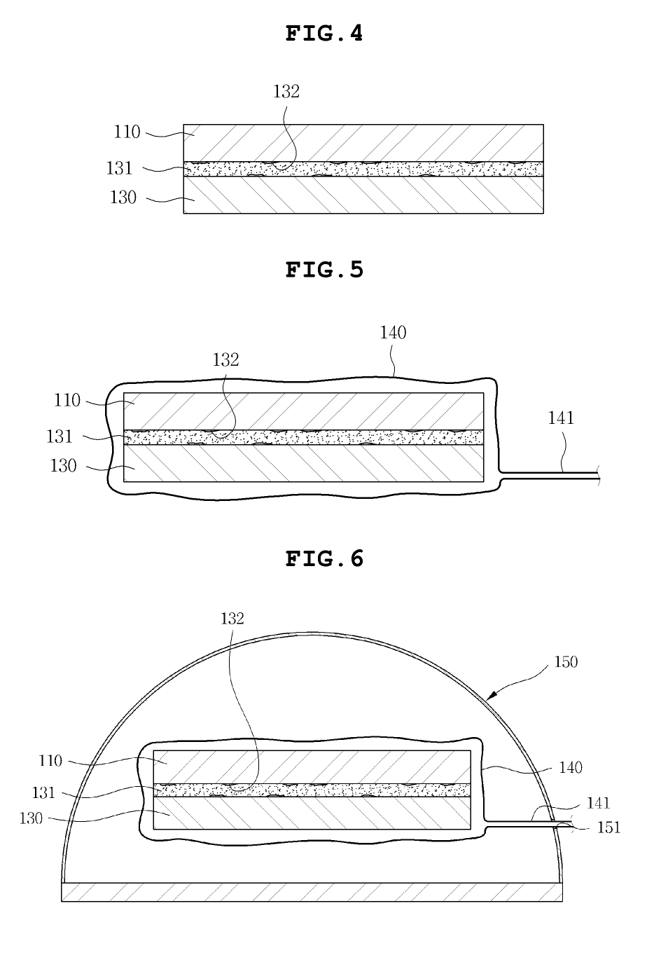

FIGS. 4 to 8 are views illustrating a method of manufacturing a touch screen device 100 according to a preferred embodiment of the present invention. A method of manufacturing the touch screen device 100 according to this embodiment is described hereafter with reference to the figure.

A method of manufacturing the touch screen device 100 according to this embodiment includes: (A) disposing the adhesive layer for the transparent substrate of the touch screen 110 and a stacked member; (B) disposing the transparent substrate of the touch screen 110, the stacked member, and the adhesive layer into a vacuum bag 140, disposing the vacuum bag 140 into a chamber 150, and then removing voids formed between the transparent substrate and the adhesive layer and between the stacked member and the adhesive layer by pressurizing and heating the inside of the chamber 150; and (C) extracting the touch screen device 100 with the transparent substrate of the touch screen 110, the stacked member, and the adhesive layer.

In this configuration, the stacked member implies all members that can be stacked on the transparent substrate 111 of the touch screen 110 in manufacturing the touch screen device 100, for example, may be a the window plate 120, the display 130, opposite different transparent substrates 111 forming the same touch screen 110, the transparent electrodes 112, anti-reflective layer (not shown), anti-finger print layer (not shown), or other touch screens (not shown) etc. That is, the stacked member may be the window plate 120 and the adhesive layer may be the first adhesive layer 121, or the stacked member may be the opposite different transparent substrates 111 and the adhesive layer may be the spacer 113. As an example, it is described in this embodiment when the stacked member is the display 130 and the adhesive layer is the second adhesive layer 131. However, the present invention is not limited thereto.

Further, although FIGS. 4 to 8 did not show the window plate 120 and the first adhesive layer 121 and the detailed configuration of the touch screen 110, for the convenience of illustration and description, and it should be appreciated that the present invention is not limited thereto.

As shown in FIG. 4, the second adhesive layer 131 is first disposed between the transparent substrate of the touch screen and the display 130.

In this state, the transparent substrate of the touch screen 110 and the display 130 may be temporarily bonded by the adhesive force of the second adhesive layer 131. Alternatively, they may be not be boned, but positioned with alignment marks arranged. On the other hand, the second adhesive layer 131 is an optical clear adhesive (OCA), and for example, may be made of a material that has adhesion when heated, such as silicon, polyurethane, PVC, and acryl-adhesives.

After the second adhesive layer 131 is positioned between the transparent substrate of the touch screen 110 and the display 130, the air layer may fail to dissipate and remain as voids 132 between the transparent substrate of the touch screen 110 and the second adhesive layer 131 and/or between the display 130 and the second adhesive layer 131. The air bubbles 132 may make spots in the picture and prevent the user from seeing a clear image on the display 130.

As shown in FIG. 5, the laminate of the stacked transparent substrate of the touch screen 110, display 130, and second adhesive layer 131 is next disposed into the vacuum bag 140.

In this configuration, the vacuum bag 140 is a part that can keep the inside vacuum by discharging the internal air through an air outlet 141. Further, the vacuum bag 140 is made of a soft material such that it can maintain a vacuum state, regardless of the size of the laminate of the transparent substrate of the touch screen 110, the display 130, and the second adhesive layer 131. Further, since the vacuum bag 140 is made of a soft material, it is possible to efficiently use only a desired space, as compared with when it is made of a rigid material, such that it is possible to save the time and energy for reaching a vacuum state.

As shown in FIG. 6, the vacuum bag 140 accommodating the laminate of the transparent substrate of the touch screen 110, the display 130, and the second adhesive layer 131 is next disposed into the chamber 150.

In this configuration, the chamber 150 is a device that can heat and pressurize, and preferably big enough to accommodate the vacuum bag 140. Further, the chamber 150 may have an opening 151 to allow the air outlet 141 of the vacuum bag 140 to be led to the outside.

Further, for example, an autoclave may be used for the chamber 150. The autoclave is a heat-resistant and pressure-resistant container that performs chemical treatments, such as composition, decomposition, sublimation, and extraction, under high temperature and high pressure, commonly equipped with a mixer, vibrator, and other rotators, and the material is usually alloy steel, such as low-carbon steel, chrome, and molybdenum. The internal temperature of the container is about 150 to 600, the air pressure is about 250 to 1200 atm, or may be more than 5000 atm.

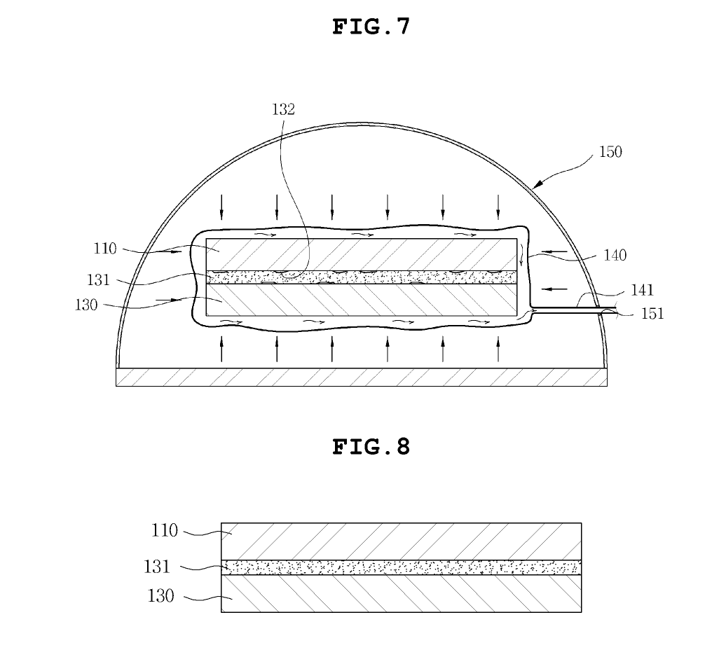

Next, as shown in FIG. 7, the inside of the chamber 150 is pressurized, or pressurized and heated, with the inside of the vacuum bag 140 maintained in a vacuum state.

As the inside of the chamber 150 is heated, the internal temperature of the vacuum bag 140 increases and the volume of the voids 132 between the second adhesive layer 131 and the transparent substrate of the touch screen 110 and/or between the display 130 and the second adhesive layer 131 increases.

Meanwhile, as the inside of the vacuum bag 140 is evacuated, the air in the expanding voids 132 is discharged outside through the air outlet 141 of the vacuum bag 140. As the inside of the chamber 150 is pressurized, the vacuum bag 140 is more rapidly reduced in volume by the pressure applied from the outside, such that the air remaining in the vacuum bag 140 can be more quickly discharged through the air outlet 141. Therefore, the display 130 can bond more strongly with the touch screen 110.

Next, as shown in FIG. 8, the touch screen device 100, the laminate of the transparent substrate of the touch screen 110, the display 130, and the second adhesive layer 131, is extracted from the chamber 150 and the vacuum bag 140.

In this process, the touch screen device 100 can be extracted after the heat and pressure applied to the chamber 150 are removed and the vacuum of the vacuum bag 140 is removed.

The touch screen device 100 according to a preferred embodiment shown in FIG. 8 can be achieved by the manufacturing process.

On the other hand, although it was described in this embodiment when the laminate of the transparent substrate of the touch screen 110, the second adhesive layer 131, and the display 130 is put in the vacuum bag 140 and then put in the chamber 150, and the vacuum bag 140 is evacuated while at the same time the chamber 150 is heated and pressurized, this is just an example, and it may be possible to put the laminate in the vacuum bag 140 and evacuate the vacuum bag 140, and then put the vacuum bag 140 in the chamber 150 and heat and pressurize the chamber 150.

According to the present invention, the method of manufacturing a touch screen device improves visibility by removing voids generated in the adhesive layer when the touch screen and the stacked member are bonded throughout the surfaces, using the vacuum bag and the chamber. That is, it is possible to prevent an image from being refracted or distorted through a display.

Further, according to the present invention, when the stacked member is the display, air layer is not formed between the touch screen and the display, such that transmittance is improved. Further, according to the present invention, since the inside of the vacuum bag is kept vacuum while the inside of the chamber is pressurized, or heated and pressurized, such that it is possible to rapidly discharge the air in the voids to the outside of the vacuum bag.

Although the embodiments of the present invention has been disclosed for illustrative purposes, it will be appreciated that a method of manufacturing a touch screen device according to the invention is not limited thereby, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

1. A method of manufacturing a touch screen device, comprising:
(A) disposing an adhesive layer for a transparent substrate of a touch screen and a stacked member;
(B) disposing the transparent substrate of the touch screen, the stacked member, and the adhesive layer into a vacuum bag, disposing the vacuum bag into a chamber, and then removing voids formed between the transparent substrate and the adhesive layer, between the stacked member and the adhesive layer, or both of them by pressurizing, or pressurizing and heating the inside of the chamber; and
(C) extracting the transparent substrate of the touch screen, the stacked member, and the adhesive layer from the chamber and the vacuum bag.

2. The method of manufacturing a touch screen device as set forth in claim 1, wherein step (B) includes:
(B1) disposing the transparent substrate of the touch screen, the stacked member, and the adhesive layer into the vacuum bag and then disposing the vacuum bag into the chamber; and
(B2) removing voids formed between the transparent substrate and the adhesive layer, between the stacked member and the adhesive layer, or both of them by pressurizing, or heating and pressurizing the inside of the chamber, with the inside of the vacuum bag maintained in a vacuum state.

3. The method of manufacturing a touch screen device as set forth in claim 1, wherein step (B) includes:
(B1) disposing the transparent substrate of the touch screen, the stacked member, and the adhesive layer into the vacuum bag and keeping the inside of the vacuum bag vacuumed; and
(B2) disposing the vacuum bag into the chamber and removing voids formed between the transparent substrate and the adhesive layer, between the stacked member and the adhesive layer, or both of them by pressurizing, or heating and pressurizing the inside of the chamber.

4. The method of manufacturing a touch screen device as set forth in claim 1, wherein the stacked member is a display.

5. The method of manufacturing a touch screen device as set forth in claim 1, wherein the stacked member is a window plate protecting the touch screen.

6. The method of manufacturing a touch screen device as set forth in claim 1, wherein the stacked member is another substrate opposite to the transparent substrate of the touch screen.

7. The method of manufacturing a touch screen device as set forth in claim 1, wherein step (A) includes:
(A1) disposing an adhesive layer between the transparent substrate of the touch screen and the stacked member; and
(A2) temporarily bonding the transparent substrate with the stacked member, using adhesion of the adhesive layer.
